(19) United States
(12) Patent Application Publication
(10) Pub. No.: US 2022/0147595 A1
(43) Pub. Date: May 12, 2022

(54) FASTER MATRIX MULTIPLICATION VIA SPARSE DECOMPOSITION

(71) Applicant: YISSUM RESEARCH DEVELOPMENT COMPANY OF THE HERBREW UNIVERSITY OF JERUSALEM LTD., Jerusalem (IL)

(72) Inventors: Oded SCHWARTZ, Kiryat Ono (IL); Gal BENIAMINI, Maccabim (IL)

(21) Appl. No.: 17/437,816

(22) PCT Filed: Mar. 12, 2020
(86) PCT No.: PCT/IL2020/050302

§ 371 Date: Sep. 9, 2021

Related U.S. Application Data
(60) Provisional application No. 62/816,979, filed on Mar. 12, 2019.

(51) Int. Cl. G06F 17/16

(52) U.S. Cl. CPC G06F 17/16

(57) ABSTRACT

A system comprising: at least one hardware processor; and a non-transitory computer-readable storage medium having program instructions embodied therewith, the program instructions executable by said at least one hardware processor to: receive a first matrix and a second matrix, compute a first transformation of said first matrix, to obtain a transformed said first matrix, compute a second transformation of said second matrix, to obtain a transformed said second matrix, apply a bilinear computation to said transformed first matrix and said transformed second matrix, thereby producing a transformed multiplied matrix; and apply a third transformation to said transformed multiplied matrix, to obtain a product of said first and second matrices, wherein at least one of said first, second, and third transformations is a non-homomorphic transformation into a linear space of any intermediate dimension.

### CROSS-REFERENCE TO RELATED APPLICATIONS

This application claims the benefit of priority of U.S. Provisional Patent Application No. 62/816,979, filed Mar. 12, 2019, entitled “Faster Matrix Multiplication Via Sparse Decomposition”, which is incorporated herein by reference in its entirety.

### BACKGROUND

The invention relates to the field of computerized mathematical applications.

Matrix multiplication is used in a wide range of computerized applications, from image processing to genetic analysis. For example, matrix multiplication is used in cryptography, random numbers, error correcting codes, and image processing. One example is in cryptanalysis, where chained operations described as matrices must be multiplied together before being analyzed for flaws. Another example is in the design of random-number generators, where exponentiation (i.e. repeated multiplication) of dense matrices is used to determine the period and quality of random number generators. The results of matrix mathematics can be seen in every computer-generated image that has a reflection, or distortion effects such as light passing through rippling water. For example, graphics cards use matrix mathematics to account for reflection and for refraction.

As a result of its wide usage, matrix multiplication is an integral feature of computer microprocessors, such as CPUs (Central Processing Units), GPUs (Graphic Processing Units), embedded processors, FPGAs (Field-Programmable Gate Arrays), and the like. Matrix multiplication may be part of a system kernel, such as an operating system kernel, a math library kernel, a graphics processing kernel, and/or the like. The matrix multiplication may be performed by a combination of hardware and software components that are coordinated to produce the matrix results, such as in parallel processor operating system kernels that use multiple hardware processors to perform matrix multiplications.

Many techniques have been developed to improve the computational efficiency, speed, memory use, communications use, etc., of computerized matrix multiplication. For example, Strassen's well-known matrix multiplication algorithm is a sub-cubic matrix multiplication algorithm, with a complexity of 0(n^{log}^{₂}⁷). See Volker Strassen, “Gaussian elimination is not optimal”, in &o Numerische mathematik 13, 4 (1969), 354-356. Winograd's matrix multiplication algorithm may reduce the leading coefficient from 7 to 6 by decreasing the number of additions and subtractions from 18 to 15. See Shmuel Winograd, “On multiplication of 2×2 matrices”, in Linear algebra and its applications 4, 4 (1971), 381-388.

Fast matrix multiplication algorithms are of practical use only if the leading coefficient of their arithmetic complexity is sufficiently small. Many algorithms with low asymptotic cost have large leading coefficients and are thus impractical. Thus, in practice, Strassen-Winograd's algorithm for matrix multiplication may perform better than some asymptotically faster algorithms due to these smaller hidden constants. The leading coefficient of Strassen-Winograd's algorithm may be optimal, due to a lower bound on the number of additions for matrix multiplication algorithms with 2×2 base case, obtained by Robert L. Probert, “On the additive complexity of matrix multiplication”, in SIAM J. Comput. 5, 2 (1976), 187-203. As used herein, the term “additions” may be in some circumstances used interchangeably with the word “subtraction,” as appropriate within the context.

Strassen-like algorithms are a class of divide-and-conquer algorithms which may utilize a base [symbol] n₀, m₀, k₀; t [symbol] -algorithm: multiplying an n₀×m₀ matrix by an m₀×k₀ matrix using t scalar multiplications, where n₀, m₀, k₀ and t are positive integers. When multiplying an n×m matrix by an m×k matrix, an algorithm may split the matrices into blocks (such as each of size

$$\frac{n}{{n}_{0}} \times \frac{m}{{m}_{0}}$$

$$and$$

$$\frac{m}{{m}_{0}} \times \frac{k}{{k}_{0}} ,$$

respecuvely), and may proceed block-wise, according to the base algorithm. Additions and multiplication by a scalar in the base algorithm may be interpreted as block-wise additions. Multiplications in the base algorithm may be interpreted as block-wise multiplication via recursion. As used herein, a Strassen-like algorithm may be referred to by its base case. Hence, an (n, m, k; t)-algorithm may refer to either the algorithm's base case or the corresponding block recursive algorithm, as obvious from context.

Recursive fast matrix multiplication algorithms with reasonable base case size for both square and rectangular matrices have been developed. At least some may have manageable hidden constants, and some asymptotically faster than Strassen's algorithm (e.g., Kaporin's implementation of Laderman algorithm; see Igor Kaporin, “The aggregation and cancellation techniques as a practical tool for faster matrix multiplication” in Theoretical Computer Science 315, 2-3, 469-510).

Smirnov presented several fast matrix multiplication algorithms derived by computer aided optimization tools, including an [symbol] 6,3,3; 40 [symbol] -algorithm with asymptotic complexity of 0(n^{log}^{₅₄}⁴⁰^{³}), i.e. faster than Strassen's algorithm. See AV Smirnov, “The bilinear complexity and practical algorithms for matrix multiplication”, in Computational Mathematics and Mathematical Physics 53, 12 (2013), 1781-1795. Ballard and Benson later presented several additional fast Strassen-like algorithms, found using computer aided optimization tools as well. They implemented several Strassen-like algorithms, including Smirnov's (6,3,3; 40)-algorithm, on shared-memory architecture in order to demonstrate that Strassen and Strassen-like algorithms can outperform classical matrix multiplication in practice (such as Intel's Math Kernel Library), on modestly sized problems (at least up to n=13000), in a shared-memory environment. Their experiments also showed Strassen's algorithm outperforming Smirnov's algorithm in some of the cases. See Austin R. Benson and Grey Ballard, “A framework for practical parallel fast matrix multiplication” in ACM SIGPLAN Notices 50, 8 (2015), 42-53.

Bodrato introduced the intermediate representation method, for repeated squaring and for chain matrix multiplication computations. See Marco Bodrato, “A Strassen-like matrix multiplication suited for squaring and higher power computation”, in Proceedings of the 2010 International Symposium on Symbolic and Algebraic Computation, ACM, 273-280. This enables decreasing the number of additions between consecutive multiplications. Thus, he obtained an algorithm with a 2×2 base case, which uses 7 multiplications, and has a leading coefficient of 5 for chain multiplication and for repeated squaring, for every multiplication outside the first one. Bodrato also presented an invertible linear function which recursively transforms a 2^{k}×2^{k} matrix to and from the intermediate transformation. While this is not the first time that linear transformations are applied to matrix multiplication, the main focus of previous research on the subject was on improving asymptotic performance rather than reducing the number of additions.

Karstadt and Schwartz (2017) recently demonstrated a technique that reduces the leading coefficient by introducing fast 0(n²log n) basis transformations, applied to the input and output matrices. See Elaye Karstadt and Oded Schwartz. 2020. Matrix multiplication, a little faster.Journal of the ACM (JACM) 67, 1 (2020), 1-31.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having program instructions embodied therewith, the program instructions executable by said at least one hardware processor to: receive a first matrix and a second matrix, compute a first transformation of said first matrix, to obtain a transformed said first matrix, compute a second transformation of said second matrix, to obtain a transformed said second matrix, apply a bilinear computation to said transformed first matrix and said transformed second matrix, thereby producing a transformed multiplied matrix; and apply a third transformation to said transformed multiplied matrix, to obtain a product of said first and second matrices, wherein at least one of said first, second, and third transformations is a non-homomorphic transformation into a linear space of any intermediate dimension.

There is also provided, in an embodiment, a method comprising: receiving a first matrix and a second matrix; computing a first transformation of said first matrix, to obtain a transformed said first matrix; computing a second transformation of said second matrix, to obtain a transformed said second matrix; applying a bilinear computation to said transformed first matrix and said transformed second matrix, thereby producing a transformed multiplied matrix; and applying a third transformation to said transformed multiplied matrix, to obtain a product of said first and second matrices, wherein at least one of said first, second, and third transformations is a non-homomorphic transformation into a linear space of any intermediate dimension.

There is further provided, in an embodiment, a computer program product comprising a non-transitory computer-readable storage medium having program instructions embodied therewith, the program instructions executable by at least one hardware processor to: receive a first matrix and a second matrix; compute a first transformation of said first matrix, to obtain a transformed said first matrix; compute a second transformation of said second matrix, to obtain a transformed said second matrix; apply a bilinear computation to said transformed first matrix and said transformed second matrix, thereby producing a transformed multiplied matrix; and apply a third transformation to said transformed multiplied matrix, to obtain a product of said first and second matrices, wherein at least one of said first, second, and third transformations is a non-homomorphic transformation into a linear space of any intermediate dimension.

In some embodiments, the non-homomorphic transformation is a decomposition.

In some embodiments, the decomposition is a full decomposition.

In some embodiments, the method further comprises selecting, and the program instructions are further executable select, which at least one of said first, second, and third transformations is a non-homomorphic transformation into a linear space of any intermediate dimension.

In some embodiments, the selecting is based, at least in part, on a dimension of each of said first and second matrices.

In some embodiments, the decomposition comprises a set of fast recursive transformations.

In some embodiments, the decomposition is determined by solving at least one sparsification problem.

In some embodiments, the method further comprises using, and the program instructions are further executable to use, (i) a first encoding matrix for said first transformation, (ii) a second encoding matrix for said second transformation, and (iii) a decoding matrix for said third transformation, wherein said at least one sparsification problem is at least one from the group consisting of: sparsification of said first encoding matrix, sparsification of said second encoding matrix, and sparsification of said decoding matrix.

In some embodiments, the at least one sparsification problem comprises simultaneously solving three sparsification problems, one for each of: said first encoding matrix, said second encoding matrix, and said decoding matrix.

In some embodiments, a leading coefficient of an arithmetic complexity of the bilinear computation is 2.

There is further provided, in an embodiment, a system comprising at least one hardware processor; and a non-transitory computer-readable storage medium having program instructions embodied therewith, the program instructions executable by said at least one hardware processor to: receive at least two matrices; compute a transformation of each of said at least two matrices, to obtain at least two respective transformed matrices; and perform one or more computations with respect to at least some of said at least two respective transformed matrices, wherein at least one of said transformations is a non-homomorphic transformation into a linear space of any intermediate dimension.

There is further provided, in an embodiment, a method comprising: receiving at least two matrices; computing a transformation of each of said at least two matrices, to obtain at least two respective transformed matrices; and performing one or more computations with respect to at least some of said at least two respective transformed matrices, wherein at least one of said transformations is a non-homomorphic transformation into a linear space of any intermediate dimension.

There is further provided, in an embodiment, a computer program product comprising a non-transitory computer-readable storage medium having program instructions embodied therewith, the program instructions executable by at least one hardware processor to: receive at least two matrices; compute a transformation of each of said at least two matrices, to obtain at least two respective transformed matrices; and perform one or more computations with respect to at least some of said at least two respective transformed matrices, wherein at least one of said transformations is a non-homomorphic transformation into a linear space of any intermediate dimension.

In some embodiments, at least one of the one or more computations is a bilinear computation applied to two of said respective transformed matrices, thereby producing multiplied said two respective transformed matrices.

There is further provided, in an embodiment, a system comprising at least one hardware processor; and a non-transitory computer-readable storage medium having program instructions embodied therewith, the program instructions executable by said at least one hardware processor to: receive a first matrix and a second matrix, and apply a sub-cubic multiplication algorithm to compute a product of said first and second matrices, wherein a leading coefficient of an arithmetic complexity of said computing is less than 3.

There is further provided, in an embodiment, a method comprising receiving a first matrix and a second matrix, and applying a sub-cubic multiplication algorithm to compute a product of said first and second matrices, wherein a leading coefficient of an arithmetic complexity of said computing is less than 3.

There is further provided, in an embodiment, a computer program product comprising a non-transitory computer-readable storage medium having program instructions embodied therewith, the program instructions executable by at least one hardware processor to: receive a first matrix and a second matrix, and apply a sub-cubic multiplication algorithm to compute a product of said first and second matrices, wherein a leading coefficient of an arithmetic complexity of said computing is less than 3.

In some embodiments, the leading coefficient of an arithmetic complexity of said computing is 2.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows schematically an exemplary computerized system 100 for matrix multiplication using w into a linear space of any intermediate dimension, in accordance with an embodiment of the present invention;

FIG. 2 is a flowchart 200 of a method for matrix multiplication using decompositions that are transformations which are not homomorphisms into a linear space of any intermediate dimension, in accordance with an embodiment of the present invention;

FIGS. 3A-3D show a comparison of the dimensions of encoding/decoding transformations of recursive-bilinear, alternative basis, decomposed, and fully decomposed algorithms, in accordance with an embodiment of the present invention;

FIG. 4 shows a full decomposition scheme, in accordance with an embodiment of the present invention;

FIG. 5 shows a graph comparing the arithmetic complexity of the classical algorithm, [symbol] 3,3,3; 23 [symbol] -algorithm, alternative basis [symbol] 3,3,3; 23 [symbol] -algorithm, decomposed [symbol] 3,3,3; 23 [symbol] -algorithm, and fully decomposed [symbol] 3,3,3; 23 [symbol] -algorithm, in accordance with an embodiment of the present invention;

FIG. 6 shows examples of decomposed algorithms, in accordance with an embodiment of the present invention; and

FIG. 7 shows an optimal decomposition of the [symbol] 3,3,3; 23 [symbol] -algorithm, in accordance with an embodiment of the present invention.

### DETAILED DESCRIPTION

Disclosed herein is a computerized system, method, and computer program product for performing faster matrix multiplication via sparse decomposition. In some embodiments, the present disclosure provides for matrix multiplication using decompositions that are transformations which are not necessarily homomorphisms into a linear space of any intermediate dimension.

In some embodiments, a fast matrix multiplication algorithm of the present disclosure provides significantly improved leading coefficients, without a reduction in asymptotic complexity.

Many algorithms with low asymptotic cost have large leading coefficients, and are thus impractical. Karstadt and Schwartz (2017) have recently demonstrated a technique that reduces the leading coefficient by introducing fast 0(n²logn) basis transformations, applied to the input and output matrices.

Matrix Multiplication is a fundamental computation kernel, used in many parallel and sequential algorithms. Thus, improving matrix Multiplication performance has attracted the attention of many researchers. Strassen's algorithm was the first sub-cubic matrix multiplication algorithm. Since then, research regarding fast multiplication algorithms has bifurcated into two main streams.

The first focuses on deriving asymptotic improvements by reducing the exponent of the arithmetic complexity. Often, these improvements come at the cost of large “hidden constants,” rendering them impractical. Moreover, the aforementioned algorithms are typically only applicable to matrices of very large dimensions, further restricting their practicality.

The second line of research focuses on obtaining asymptotically fast algorithms while maintaining lower hidden costs; allowing multiplication of reasonably-sized matrices. These methods are thus more likely to have practical applications. Within this line of research, several algorithms have been discovered via computer-aided techniques.

Previously, the problem of matrix multiplication was reduced to the triple-product trace, allowing the derivation of several sub-cubic algorithms with relatively small base cases, such as [symbol] 70,70,70; 143640 [symbol] , [symbol] 40,40,40; 36133 [symbol] , and [symbol] 18,18,18; 3546 [symbol] , allowing multiplication in Θ(n^{ω}^{₀}), where ω₀=log₇₀143640≈2.79, ω₀=log₄₀36133≈2.84, and ω₀=log₁₀3546≈2.82, respectively. Notice that the notation [symbol] n, m, k; t [symbol] refers to an algorithm with a base case that multiplies matrices of dimension n×m, m×k using t scalar multiplications.

Later, a computer-aided search was used to find base cases. Notable among these algorithms are [symbol] 6,3,3; 40 [symbol] -algorithm, and [symbol] 4,3,3; 29 [symbol] -algorithm, allowing multiplication in Θ(n^{ω}^{₀}), where ω₀=log₅₄(40³)≈2.774 and ω₀=log₃₆(29³)≈2.818, respectively. Similarly, computer-aided techniques were further used to derive additional multiplication algorithms, such as [symbol] 5,2,2; 18 [symbol] and [symbol] 3,2,2; 11 [symbol] , allowing multiplication in Θ(n^{ω}^{₀}), where ω₀=log₂₀18³≈2.89 and ω₀=log₁₂11³≈2.89, respectively.

In some embodiments, the present disclosure generalizes this technique, by allowing larger bases for the transformations while maintaining low overhead. Thus, in some embodiments, the present disclosure accelerates several known matrix multiplication algorithms, beyond what is known to be possible using previous techniques. Of particular interest are a few new sub-cubic algorithms with a leading coefficient 2, matching that of classical matrix multiplication. For example, an algorithm may be obtained with arithmetic complexity of 2n^{log}^{₃}²³+0(n^{log323}) compared to 2n³−n² of the classical algorithm. Such new algorithms can outperform previous ones (classical included) even on relatively small matrices. Thus, there are obtained lower bounds matching the coefficient of several algorithms, proving them to be optimal.

The hidden constants of the arithmetic complexity of recursive-bilinear algorithms, including matrix multiplication, is determined by the number of linear operations performed in the base case. Strassen's (2,2,2; 7)-algorithm has a base-case with 18 additions, resulting in a leading coefficient of 7. This was later reduced to 15 additions by Winograd, decreasing the leading coefficient from 7 to 6. Probert and Bshouty showed that 15 additions are necessary for any (2,2,2; 7)-algorithm, leading to the conclusion that the leading coefficient of Strassen-Winograd is optimal for the 2×2 base case.

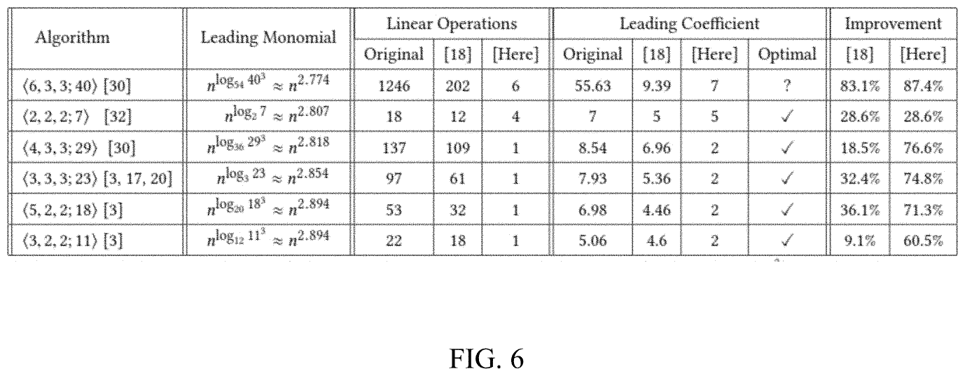

Karstadt and Schwartz recently observed that these lower-bounds implicitly assume the input and output are given in the standard basis. Discarding this assumption allows further reduction in the number of arithmetic operations from 15 to 12, decreasing the leading coefficient to 5. The same approach, applied to other algorithms, resulted in a significant reduction of the corresponding leading coefficients (See FIG. 6). Moreover, Karstadt and Schwartz extended the lower bounds due to Probert and Bshouty by allowing algorithms that include basis transformations, thus proving that their [symbol] 2,2,2; 7 [symbol] -algorithm obtains an optimal leading coefficient in the alternative basis regime.

Key to the approach of Karstadt and Schwartz are fast basis transformations, which can be computed in 0(n²logn), asymptotically faster than the matrix multiplication itself. These transformations can be viewed as an extension of the “intermediate representation” approach, which previously appeared in Bodrato's method for matrix squaring.

Cenk and Hassan developed a technique for computing multiplication algorithms, such as Strassen's, which utilizes memorization, allowing a reduction of the leading coefficient. Their approach obtains a [symbol] 2,2,2; 7 [symbol] -algorithm with a leading coefficient of 5, as in Karstadt and Schwartz, albeit with larger exponents in the low-order monomials.

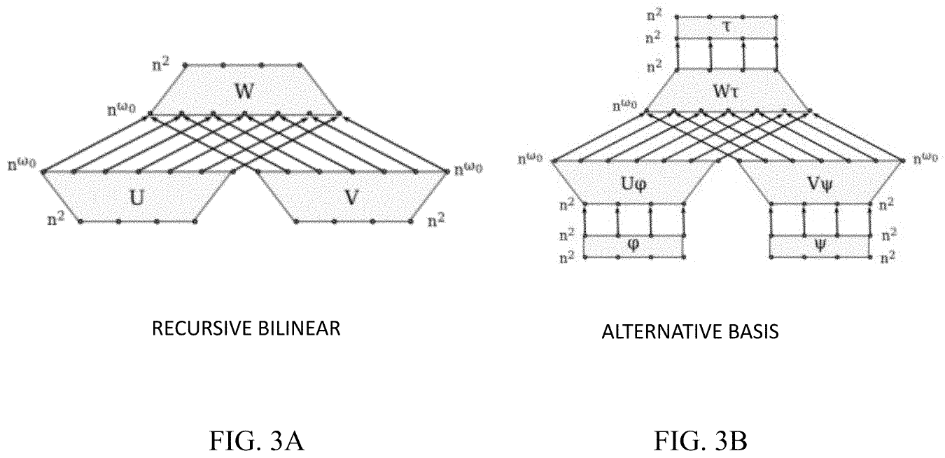

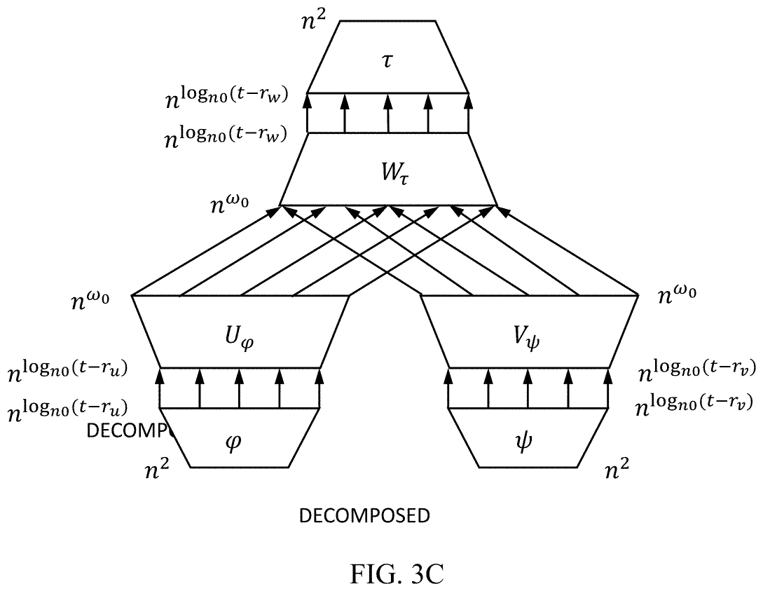

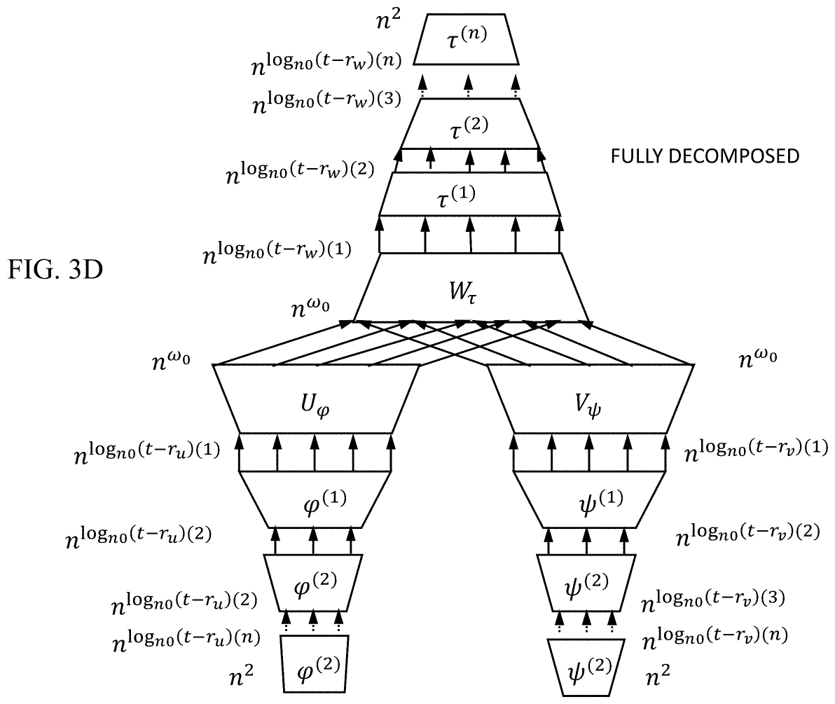

The present invention extends Karstadt and Schwartz's method for Alternative Basis Multiplication. While their basis transformations are homomorphisms over the same linear space (i.e., changes of basis), the present invention considers non-homomorphic transformations into a linear space of any intermediate dimension (see FIGS. 3A-3D). Such transformations incur costs of low-order monomials, as opposed to the 0(n²logn) cost of basis transformations, but allow further reduction of the leading (and other) coefficients.

The mixed-product property of the Kronecker Product was used to rearrange the computation graph, allowing aggregation of all the decompositions into a single stage of the algorithm. As the aforementioned transformations correspond to low-order monomials, part of the computation was intentionally “offloaded” onto them. To this end, decompositions in which the matrices of maps contributing to the leading monomial are sparse were used, whereas the matrices of transformations contributing to low-order monomials may be relatively dense.

The decomposition scheme was applied to several fast matrix multiplication algorithms, resulting in significant reduction of their arithmetic complexity compared to previous techniques. Several decomposed sub-cubic algorithms with leading coefficient 2, matching that of the classical multiplication algorithm, were found. Such algorithms outperform previous ones (classical included) even on small matrices. In particular, decompositions with said properties for [symbol] 4,3,3; 29 [symbol] -algorithm, [symbol] 3,3,3; 23 [symbol] -algorithm, [symbol] 5,2,2; 18 [symbol] -algorithm and [symbol] 3,2,2; 11 [symbol] -algorithm were obtained. Furthermore, optimally decomposed algorithms maintain the leading coefficient of 2 when converted into square (nmk , nmk, nmk; t³)-algorithms (see FIG. 6).

Lastly, lower bounds for several of the leading coefficients were obtained. The lower bound for alternative basis [symbol] 2,2,2; 7 [symbol] -algorithms was extended, showing that even in the new framework, the leading coefficient of any [symbol] 2,2,2; 7 [symbol] -algorithm is at least 5, matching the best known coefficient. Furthermore, the leading coefficient of any [symbol] n, m, k; t [symbol] -algorithm in the new framework is at least 2, matching several of the obtained algorithms.

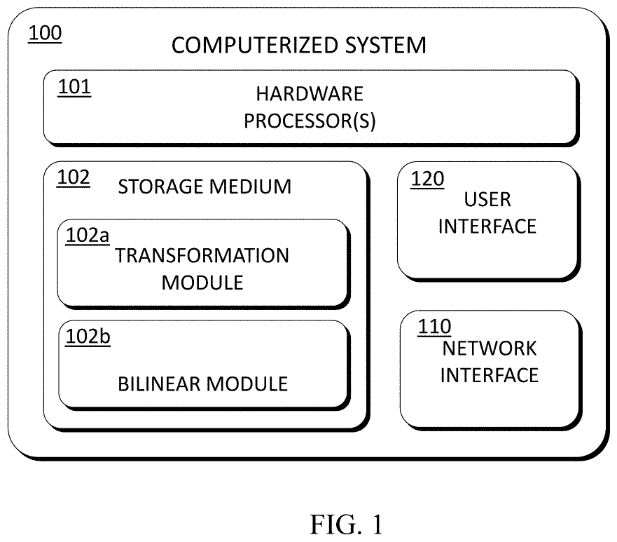

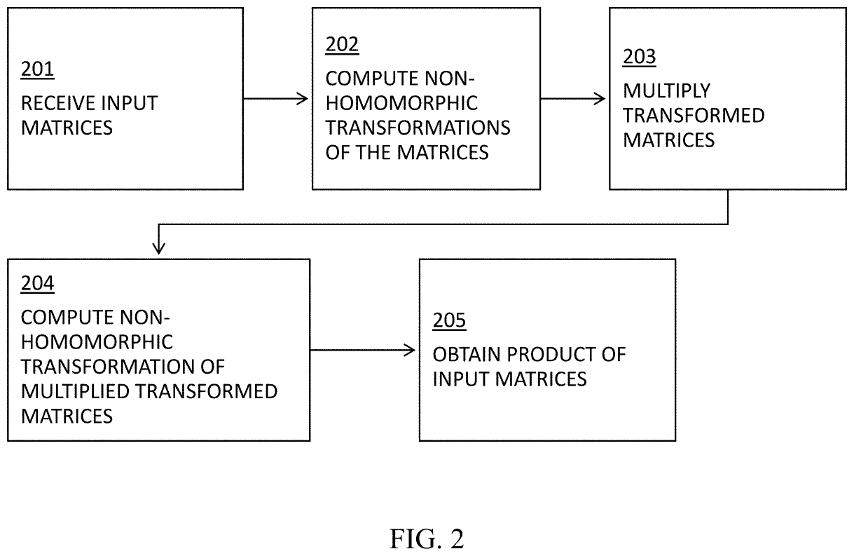

Reference is made to FIG. 1 which shows schematically an exemplary computerized system 100 for matrix multiplication using decompositions that are transformations which are not necessarily homomorphisms into a linear space of any intermediate dimension, in accordance with an embodiment of the present invention, and to FIG. 2, which shows a flowchart 200 of a method for matrix multiplication using decompositions that are transformations which are not homomorphisms into a linear space of any intermediate dimension, in accordance with an embodiment of the present invention. These embodiments are examples of possible embodiments that utilize the disclosed technique, and other embodiments may be envisions, such as field-programmable gate arrays embodiments, and/or the like. For example, the method may compute a basis transformation a priori, on the fly, retrieved from a repository, provided as a service, and/or the like.

Computerized system 100 comprises one or more hardware processors 101, a user interface 120, a network interface 110, and one or more computer-readable, non-transitory, storage mediums 102.

System 100 as described herein is only an exemplary embodiment of the present invention, and in practice may have more or fewer components than shown, may combine two or more of the components, or a may have a different configuration or arrangement of the components. The various components of system 100 may be implemented in hardware, software or a combination of both hardware and software. In various embodiments, system 100 may comprise a dedicated hardware device, or may form an addition to/or extension of an existing device. In some embodiments, system 100 may comprise numerous general purpose or special purpose computing system environments or configurations. Examples of computing systems, environments, and/or configurations that may be suitable for use with system 100 include, but are not limited to, personal computer systems, server computer systems, thin clients, thick clients, hand-held or laptop devices, multiprocessor systems, microprocessor-based systems, minicomputer systems, mainframe computer systems, distributed cloud computing environments that include any of the above systems or devices, and the like.

On non-transitory storage medium(s) 102 is stored program code, optionally organized in dedicated, specialized, non-standard software modules, that when executed on hardware processor(s) 101, cause hardware processor(s) 101 to perform non-standard actions resulting in matrix multiplication. The non-standard transformation module 102a optionally receives, at 201, input matrices, and based on the matrix multiplier technique, optionally determines, at 202, decompositions of the matrices that are transformations which are not homomorphisms into a linear space of any intermediate dimension. Transformation module 102a then applies the decompositions to transform, at 203, the input matrices. A bilinear module 102b multiplies, at 204, the transformed input matrices to produce a transformed results matrix, which is inverse transformed by transformation module 102a to produce, at 205, the resulting multiplied matrix.

### Notations

Let t∈ [symbol] . The notation [t] represents the set:

[t]=1,2, . . . , t.

Let R be a ring and let l, n, m∈ [symbol] . Denote N=n^{l}, M=m^{l}. Let A∈R^{N×M} be a matrix. Denote A_{i,j} the (i,j)-th block of size

$$\frac{N}{n} \times \frac{M}{m} .$$

The block-row order vectorization of A corresponding to blocks of size

$$\frac{N}{n} \times \frac{M}{m} ,$$

is recursively defined as follows:

\vec{A}=(\vec{A}_{1,1} . . . \vec{A}_{1,m} . . . \vec{A}_{n,1} . . . \vec{A}_{n,m})^{T}.

Denote the number of non-zero entries in a matrix by (A)=|x∈A: x≠0|

Denote the number of non-singleton entries in a matrix by (A)=|x∈A: x∉0, +1, −1|.

Let R be a ring and let l, n, m∈ [symbol] . Denote N=n^{l},M=m^{l}. Let a∈R^{NM} be a vector, and let:

$$∀ i ∈ [ n m ] \text{:} {a}^{( i )} = ( {a}_{\frac{N M}{n m} ( i - 1 ) + 1} , … , {a}_{\frac{N M}{n m} i} ) \qquad$$

The block segmentation of a is denoted:

$$\hat{a} = {( {a}^{( 1 )} , … , {a}^{( n m )} )}^{T} ∈ {( {R}^{\frac{N M}{n m}} )}^{n m} \qquad$$

### Recursive Bilinear Algorithms

Recursive bilinear algorithms use a divide-and-conquer strategy. They utilize a fixed-size base case, allowing fast computation of small inputs. Recursive-bilinear algorithms representing matrix multiplication are denoted by their base case using the following notation.

As noted above, a recursive-bilinear matrix multiplication algorithm with a base case that multiplies matrices of dimension n×m and m×k using t scalar multiplications, is denoted by [symbol] n, m, k; t [symbol] .

Any such algorithm can be naturally extended into a recursive-bilinear algorithm which multiplies matrices of dimensions n^{l}×m^{l}, m^{l}×k^{l}, where l∈ [symbol] . The input matrices are first segmented into blocks of sizes

$$\frac{{n}^{l}}{n} \times \frac{{m}^{l}}{m} , \\ \frac{{m}^{l}}{m} \times \frac{{k}^{l}}{k} ,$$

respectively. Subsequently, linear combinations of blocks are performed directly, while scalar multiplication of blocks is computed via recursive invocations of the base algorithm. Once the blocks are decomposed into single scalars, multiplication is performed directly.

The asymptotic complexity of an [symbol] n, n, n; t [symbol] -algorithm is 0(n^{ω}^{₀}), where ω₀=logₙ(t). In the rectangular case, the exponent of an [symbol] n, m, k; t [symbol] -algorithm is ω₀=logₙₘₖ(t³).

Any bilinear algorithm, matrix multiplication included, can be described using three matrices, in the following form:
Bilinear Representation: Let R be a ring, and let n, m, k∈ [symbol] . Let f(x, y):(R^{n·m}×R^{m·k})→R^{n·k} be a bilinear algorithm that performs t multiplications. There exist three matrices: U∈R^{t×n·m}, V∈R^{t×m·k}, W∈R^{t×n·k}, such that:

∀x∈R^{n×m}, y∈R^{m×k}: f(x,y)=W^{T}((U·\vec{x})⊙(V·\vec{y}))

Where ⊙ is the Hadamard (element-wise) product.

Let R be a ring, and let UÅR^{t×nm}, V∈R^{t×mk}, W∈R^{t×nk} be three matrices. A recursive-bilinear algorithm with the encoding matrices U, V and the decoding matrix W, is defined as follows:

```
Algorithm 1: Recursive-Bilinear Algorithm [symbol]
Input: a ϵ R^{(nm)l}, b ϵ R^{(mk)l}
Output:  c = [symbol]  (a,b)
  1:  procedure [symbol] (a, b)
  2:  ã = U · â  >Transform inputs
  3:  \tilde{b} = V · \hat{b}
  4:  if l = 1 then  >Base Case
  5:  \tilde{c} = W^{T} · (ã ⊙ \tilde{b})  >Scalar multiplication
  6:  else
  7:  for r = 1 to t do
  8:  \tilde{c}[r] = [symbol]  (ã[r], \tilde{b}[r]) >Recursion
  9:  return W^{T} · \tilde{c}
```

A recursive-bilinear algorithm defined by the matrices U,V,W is denoted by ALG_{(U,V,W)}.

The following necessary and sufficient condition characterizes the encoding and decoding matrices of matrix multiplication algorithms:
Triple Product Condition: Let R be a ring and let m, n, k, t∈ [symbol] . Let U∈R^{t×nm}, V∈R^{t×mk}, W∈R^{t×nk}. For every r∈[t], denote U_{r,(i,j)} the element in the r'th row of U corresponding to the input element Aᵢⱼ. Similarly, V_{r,(i,j)} corresponds to the input element B_{i,j}, and W_{r,(i,j)} to the output element (AB)_{i,j}. U,V are the encoding matrices and W is the decoding matrix of an (n, m, k; t)-algorithm if and only if:

∀i₁, i₂∈[n], ∀k₁, k₂∈[m], ∀j₁, j₂∈[k]Σᵣ₌₁^{t}U_{r,(i}_{₁}ₖ_{₁}₎V_{r,(k}_{₂}ⱼ_{₁}₎W_{r,(i}_{₂}_{,j}_{₂}₎=δᵢ_{₁}_{,i}_{₂}δₖ_{₁}_{,k}_{₂}δⱼ_{₁}_{,j}_{₂}

Where δ_{i,j}=1⇔i=j
Additive Complexity: Encoding the inputs and decoding the outputs of an (n, m, k; t)-algorithm using the corresponding encoding/decoding matrices U, V, W incurs an arithmetic cost. Let qᵤ, qᵥ, q_{w} be the number of arithmetic operations performed by the encoding and decoding matrices, correspondingly. Then:
qᵤ=nnz(U)+nns(U)−rows(U)
qᵥ=nnz(V)+nns(V)−rows(V)
q_{w}=nnz(W)+nns(W)−cols(W)
Proof: Each row of U, V corresponds to a linear combination of A,B's elements. Each column of W corresponds to combinations of the multiplicands. The first non-zero entry in each row selects the first element to include in the combination (at no arithmetic cost). Each additional non-zero element indicates another element in the combination, requiring an additional arithmetic operation. If the entry is not a singleton, it requires an additional multiplication by a scalar, thus requiring two operations in total.

### Decomposed Recursive-Bilinear Algorithm

### Fast Recursive Transformation

As noted herein, the additive complexities qᵤ,qᵥ,q_{w} are determined by the amount of non-zeros and non-singletons in the matrices U,V,W. Thus, sparsifying these matrices accelerates their corresponding algorithms. To this end, a set of efficiently computable recursive transformations are now defined which will later be leveraged to increase the sparsity of the encoding/decoding matrices.

Generalization of Karstadt and Schwartz (2017): Let R be a ring. Let φ₁:R^{s}^{₁}→R^{s}^{₂} be a linear transformation. Let l∈ [symbol] and denote S₁=(s₁)^{l}, S₂=(s₂)^{l}. Let v∈R^{s}^{₁}, and denote

$$∀ i ∈ [ {s}_{1} ] \text{:} {v}^{( i )} = ( {v}_{\frac{{S}_{1}}{{s}_{1}} ( i - 1 ) + 1} , … , {v}_{\frac{{S}_{1}}{{s}_{1}} i} ) . \qquad$$

The linear map φₗ:R^{S}^{₁}→R^{S}^{₂} is recursively-defined as follows:

$${φ}_{l} ( v ) = {φ}_{1} ( \begin{matrix}{φ}_{l 1} ( {v}^{( 1 )} ) \\ {φ}_{l 1} ( {v}^{( 2 )} ) \\ ⋮ \\ {φ}_{l 1} ( {v}^{( {s}_{1} )} )\end{matrix} )$$

where φ₁ is applied to a vector of s₁ elements in

$${R}^{\frac{{S}_{1}}{{s}_{1}}} .$$

Applying the recursively-defined φₗ to the block-row order vectorization of a matrix A∈R^{N×M} yields:

$${φ}_{l} ( \vec{A} ) = {φ}_{1} ( \overleftarrow{( \begin{matrix}{φ}_{l 1} ( {\vec{A}}_{1 , 1} ) & . . . & {φ}_{l 1} ( {\vec{A}}_{1 , m} ) \\ ⋮ & ⋱ & ⋮ \\ {φ}_{l 1} ( {\vec{A}}_{n , 1} ) & . . . & {φ}_{l 1} ( {\vec{A}}_{n , m} )\end{matrix} )} )$$

### Analysis of Recursive-Bilinear Algorithms

Mixed-Product Property: Denote by ⊗ the Kronecker product. Let A, B∈R^{m}^{₁}^{×n}^{₁} and C, D∈R^{m}^{²}^{×n}^{₂} be two matrices. The following equality holds:

(A⊗B)(C⊗D)=(AC)⊗(BD)

Let R be a ring. Let φ₁:R^{s}^{₁}→R^{s}^{₂} be a linear transformation. Let l∈ [symbol] and denote S₁=(s₁)^{l}, S₂=(s₂)^{l}. Let \vec{v}∈R^{S}^{₁}. Denote by ⊗ the Kronecker product. Then:

$${φ}_{l} ( \vec{v} ) = {\underbrace{( {φ}_{1} ⊗ . . . ⊗ {φ}_{1} )}}_{l times} \cdot \vec{v} = ( {⊗}_{l} {φ}_{1} ) \cdot \vec{v}$$

Proof: The proof is by induction on l. The base case (l=1) is immediate, since:

φ₁(\vec{v})=(⊗₁φ₁)\vec{v}

Next it is assumed the claim holds for (l−1)∈ [symbol] and the fact that it holds for l is shown.

$$\begin{matrix}{φ}_{l} ( \vec{v} ) = {{φ}_{1} ( {φ}_{l - 1} ( {v}^{( 1 )} ) , {φ}_{l - 1} ( {v}^{( 2 )} ) , . . . , {φ}_{l - 1} ( {v}^{( {s}_{1} )} ) )}^{T} \\ = {{φ}_{1} ( ( {⊗}_{l - 1} {φ}_{1} ) {v}^{( 1 )} , ( {⊗}_{l - 1} {φ}_{1} ) {v}^{( 2 )} , . . . , ( {⊗}_{l - 1} {φ}_{1} ) {v}^{( {s}_{1} )} )}^{T} \\ = ( {φ}_{1} ⊗ {φ}_{1 - 1} ) \cdot \vec{v} = ( {⊗}_{l} {φ}_{1} ) \cdot \vec{v}\end{matrix} \qquad$$

where the first equality is by the definition of φₗ, the second is by the induction hypothesis, and the last equality is by the definition of the Kronecker product.

Let R be a ring. Let U∈R^{t×nm}, V∈R^{t×mk}, W∈R^{t×nk} be three matrices and let ALG_{(U,V,W)} be a recursive-bilinear algorithm defined by U,V,W. Let l∈ [symbol] and denote N=n^{l}, M=m^{l}, K=k^{l}. Let α∈R^{NM} and b∈R^{MK} be two vectors. Then:

[symbol]

(a, b)=Wₗ^{T}·((Uₗ·α)⊙(Vₗ·b))
Proof: The proof is by induction on l. The base case (l=1) is immediate, since by definition of a recursive-bilinear algorithm, ∀x∈R^{nm}, ∀y∈R^{mk}:

ALG_{(U,V,W)}(x,y)=W^{T}·((U·x)⊙^{V·y}))=W₁^{T}·((U₁·x)⊙(V₁·y))

Next it is assumed the claim holds for (l=1)∈ [symbol] and that fact that it holds for l is shown. Denote â, \hat{b} the block segmentations of a and b, respectively. Let:

∀i∈[t]:cᵢ= [symbol] ((U·â)ᵢ, (V·\hat{b})ᵢ)

By the induction hypothesis:

cᵢ=Wₗ₋₁^{T}·((Uₗ₋₁·(U·â)ᵢ)⊙(Vₗ₋₁·(V·\hat{b})ᵢ))

However:

$$( \begin{matrix}{U}_{l 1} \cdot {( U \cdot \hat{a} )}_{1} \\ ⋮ \\ {U}_{l 1} \cdot {( U \cdot \hat{a} )}_{t}\end{matrix} ) = {( \begin{matrix}{u}_{1 , 1} \cdot {U}_{l 1} & . . . & {u}_{1 , nm} \cdot {U}_{l 1} \\ ⋮ & ⋱ & ⋮ \\ {u}_{t , 1} \cdot {U}_{l 1} & . . . & {u}_{t , n m} \cdot {U}_{l 1}\end{matrix} )}_{i} \cdot \hat{a} = {U}_{l} \cdot a$$

where the last equality follows as shown herein. The same applies to V. Therefore by the definition of [symbol] :

$$\begin{matrix}A L {G}_{〈 U , V , W 〉} ( a , b ) = {W}^{T} \cdot {( {c}_{1} . . . {c}_{t} )}^{T} \\ = {W}^{T} \cdot ( \begin{matrix}{W}_{l - 1}^{T} ( {U}_{l - 1} \cdot {( U \cdot \hat{a} )}_{1} ) ⊙ ( {V}_{l - 1} \cdot {( V \cdot \hat{b} )}_{1} ) \\ ⋮ \\ {W}_{l - 1}^{T} ( {U}_{l - 1} \cdot {( U \cdot \hat{a} )}_{t} ) ⊙ ( {V}_{l - 1} \cdot {( V - \hat{b} )}_{t} )\end{matrix} ) \\ = {W}_{l}^{T} ( ( {U}_{l} \cdot a ) ⊙ ( {V}_{l} \cdot b ) )\end{matrix}$$

where the last equality follows as shown herein.

### Decomposed Bilinear Algorithm

Let U, V and W be the encoding/decoding matrices of a recursive-bilinear algorithm. Let U=U_{φ}·φ, V=V_{ψ}·ψ nd W=W_{τ}·τ be decompositions of the aforementioned matrices, and let [symbol] be a recursive-bilinear algorithm defined by the encoding and decoding matrices U_{φ}, V_{ψ} and W_{τ}. Let l∈ [symbol] and denote N=n^{l}, M=m^{l}. The Decomposed Recursive-Bilinear Algorithm is defined as follows:

Algorithm 2: Decomposed Recursive-Bilinear Algorithm
Input: a ϵ R^{N}, b ϵ R^{M}
Output: c = [symbol] (a,b)
1: function DRB(a,b)
2: ã = φₗ (a) >Transform the first input
3: \tilde{b} = φₗ (b) >Transform the second input
4: \tilde{c} = [symbol] (ã, \tilde{b}) >Recursive-bilinear phase
5: \tilde{c} = τₗ^{T} (\tilde{c}) >Transform the output
6: return c

### Correctness

In this section, it is proven that output of the Decomposed Recursive-Bilinear Algorithm (DRB) is identical to the output of a recursive-bilinear algorithm with the encoding and decoding matrices U, V and W.

Let U∈R^{t×nm}, V∈R^{t×mk}, W∈R^{t×nk} be three matrices. Let:
U_{φ}∈R^{t×(t-r}^{ᵤ}⁾φ ∈R^{(t-r}^{ᵤ}^{)×nm}τᵤ ∈[t−nm]
V_{ψ}∈R^{t×(t-r}^{ᵥ}⁾ψ ∈R^{(t-r}^{ᵥ}^{)×mk} rᵥ ∈[t−mk]
W_{τ}∈R^{t×(t-r}^{_{w}}⁾τ ∈R^{(t-r}^{_{w}}^{)×nk} r_{w} ∈[t−nk]
   where U=U_{φ}·φ, V=V_{ψ}·ψ, and W=W_{τ}·τ. We refer to U_{φ}, V_{ψ}, W_{τ}, φ, ψ, τ as a decomposition of U, V, and W with levels rᵤ,rᵥ, and r_{w}, correspondingly.

Let R be a ring. Let l∈ [symbol] and denote N=n^{l}, M=m^{l}, K=k^{l}. Let α∈R^{NM}, b∈R^{MK} be two vectors. Let U∈R^{t×nm}, V∈R^{t×mk}, and W∈R^{t×nk} be three matrices, and let U_{φ}, v_{ψ}, W_{τ}, φ, ψ, τ be a decomposition of U, V, W with levels rᵤ,rᵥ,r_{w}. Let [symbol] be a recursive-bilinear algorithm defined by U_{φ}, V_{ψ}, W_{τ}, and denote ã=φₗ(a), \tilde{b}=ψₗ(b). The following equality holds:

[symbol]

(ã, \tilde{b})=W_{τl}^{T}·((Uₗ·a)⊙(Vₗ·b))
Proof: [symbol] is a recursive-bilinear algorithm which uses the encoding/decoding matrices U₁₀₀ , V_{ψ}, W_{τ}, therefore as above, ∀x∈R^{NM}, ∀y∈R^{MK}:

[symbol]

(x,y)=W_{τl}^{T}((U_{φ}_{ₗ}·x)⊙(V_{ψ}_{ₗ}·y))

Observe the following equality:

$$\begin{matrix}{U}_{{φ}_{l}} \cdot {φ}_{l} = ( {U}_{φ} ⊗ {U}_{{φ}_{l - 1}} ) \cdot ( φ ⊗ {φ}_{l - 1} ) ) \\ = ( {U}_{φ} φ ) ⊗ ( {U}_{{φ}_{l - 1}} {φ}_{l - 1} ) \\ = U ⊗ ( {U}_{{φ}_{l - 1}} {φ}_{l - 1} ) \\ = U ⊗ . . . ⊗ U = {U}_{l}\end{matrix}$$

Similarly, V_{ψdi l}·ψₗ=Vₗ and W_{τl}·τₗ=Wₗ. Therefore, applying [symbol] to ã, \tilde{b} yields:

$$\begin{matrix}A L {G}_{〈 {U}_{φ} , {V}_{ψ} , {W}_{τ} 〉} ( \tilde{a} , \tilde{b} ) = {W}_{{τ}_{l}}^{T} ( ( {U}_{{φ}_{l}} \cdot \tilde{a} ) ⊙ ( {V}_{{ψ}_{l}} \cdot \tilde{b} ) ) \\ = {W}_{{τ}_{l}}^{T} ( ( {U}_{{φ}_{l}} \cdot {φ}_{l} \cdot a ) ⊙ ( {V}_{{ψ}_{l}} \cdot {ψ}_{l} \cdot b ) ) \\ = {W}_{{τ}_{l}}^{T} ( ( ( {U}_{{φ}_{l}} \cdot {φ}_{l} ) \cdot a ) ⊙ ( ( {V}_{{ψ}_{l}} \cdot {ψ}_{l} ) \cdot b ) ) \\ = {W}_{{τ}_{l}}^{T} \cdot ( ( {U}_{l} \cdot a ) ⊙ ( {V}_{l} \cdot b ) )\end{matrix}$$

Let R be a ring. Let l∈ [symbol] and denote N=n^{l}, M=m^{l}, K=k^{l}. Let U∈R^{t×nm}, V∈R^{t×mk}, W∈R^{t×nk} be three matrices, and let U_{φ}, V_{ψ}, W_{τ}, φ, ψ, τ be a decomposition of U, V, W with levels rᵤ,rᵥ,r_{w}. Let DRB be defined as above, and let [symbol] , [symbol] be recursive-bilinear algorithms. The output of DRB satisfies:

∀a∈R^{MN}, ∀b∈R^{MK}:DRB(a,b)= [symbol] (a, b)

Proof: Denote ã=φₗ(a), \tilde{b}=ψₗ(b). As above:

[symbol]

(ã, \tilde{b})=W_{τl}^{T}((Uₗ·a)⊙(Vₗ·b))

Therefore by the definition of DRB:

$$\begin{matrix}D R B ( a , b ) = {τ}_{l}^{T} \cdot A L {G}_{〈 {U}_{φ} , {V}_{ψ} , {W}_{τ} 〉} ( \tilde{a} , \tilde{b} ) \\ = {τ}_{l}^{T} \cdot {W}_{{τ}_{l}}^{T} \cdot ( ( {U}_{l} \cdot a ) ⊙ ( {V}_{l} \cdot b ) ) \\ = {( {W}_{{τ}_{l}} \cdot {τ}_{l} )}^{T} \cdot ( ( {U}_{l} \cdot a ) ⊙ ( {V}_{l} \cdot b ) ) \\ = {W}_{l}^{T} \cdot ( ( {U}_{l} \cdot a ) ⊙ ( {V}_{l} \cdot b ) )\end{matrix}$$

where the second equality follows from above and the fourth equality follows from the identity W_{τl}·τₗ=Wₗ above.

Let U, V and W be the encoding and decoding matrices of an (n, m, k; t)-algorithm. Then ∀A∈Rⁿ^{^{l}}^{××m}^{^{l}}, ∀B∈R^{m}^{^{l}}^{×k}^{^{l}}:

$$D R B ( \vec{A} , \vec{B} ) = A L {G}_{〈 U , V , W 〉} ( \vec{A} , \vec{B} ) = \overleftarrow{A \cdot B}$$

### Arithmetic Complexity

The arithmetic complexity of an algorithm was analyzed. To this end, the arithmetic complexity of an [symbol] n, m, k; t [symbol] -algorithm was first computed.

Let R be a ring and let ALG be a recursive-bilinear [symbol] n, m, k; t [symbol] -algorithm. Let l∈N and denote N=n^{l}, M=m^{l}, K=k^{l}. Let A∈R^{N×m},B∈R^{M×K} be two matrices. Let chq,,q, be the additive complexities of the encoding/decoding matrices. The arithmetic complexity of ALG (A, B) is:

$$\begin{matrix}{F}_{A L G} ( N , M , K ) = ( \frac{{q}_{u}}{t - nm} + \frac{{q}_{v}}{t - m k} + \frac{{q}_{w}}{t - n k} + 1 ) \cdot {t}^{l} \\ - \frac{{q}_{u}}{t - nm} \cdot N M - \frac{{q}_{v}}{t - m k} \cdot M K - \frac{{q}_{w}}{t - n k} \cdot N K\end{matrix}$$

Proof. ALG is a recursive algorithm. In each step, ALG invokes t recursive calls on blocks of size

$$\frac{N}{n} \times \frac{M}{m} and \frac{M}{m} \times \frac{K}{k} .$$

During the encoding phase, ALG performs qᵤ arithmetic operations on blocks of size

$$\frac{N M}{n m}$$

and qᵥ operations on blocks of size

$$\frac{M K}{m k} .$$

During the decoding phase, q_{w} arithmetic operations are performed on blocks of size

$$\frac{N K}{n k} .$$

### Therefore:

$${F}_{A L G} ( N , M , K ) = t \cdot {F}_{A L G} ( \frac{N}{n} , \frac{M}{m} , \frac{K}{k} ) + {q}_{u} \cdot ( \frac{N M}{n m} ) + {q}_{v} \cdot ( \frac{M K}{m k} ) + {q}_{w} \cdot ( \frac{N K}{n k} )$$

Moreover, F_{ALG}(1,1,1)=1 since multiplying two scalar values requires a single arithmetic operation. Thus:

$${F}_{A L G} ( N , M , K ) = t \cdot {F}_{A L G} ( \frac{N}{n} , \frac{M}{m} , \frac{K}{k} ) + {q}_{u} \cdot ( \frac{N M}{n m} ) + {q}_{v} \cdot ( \frac{M K}{m k} ) + {q}_{w} \cdot ( \frac{N K}{n k} ) = {\sum }_{r = 0}^{l - 1} ( ( \frac{{q}_{u} N M}{{( n m )}^{r + 1}} + \frac{{q}_{V} M K}{{( m k )}^{r + 1}} + \frac{{q}_{w} N K}{{( n k )}^{r + 1}} ) {t}^{r} ) + {t}^{l} \cdot {F}_{A L G} ( 1 , 1 , 1 ) = \frac{{q}_{u} N M}{n m} {\sum }_{r = 0}^{l - 1} ( \frac{t}{n m} ) + \frac{{q}_{V} M K}{m k} {\sum }_{r = 0}^{l - 1} ( \frac{t}{m k} ) + \frac{{q}_{w} N K}{n k} {\sum }_{r = 0}^{l - 1} ( \frac{t}{n k} ) + {t}^{l} = {q}_{u} \cdot \frac{{t}^{l} - N M}{t - nm} + {q}_{v} \cdot \frac{{t}^{l} - MK}{t - mk} + {q}_{w} \cdot \frac{{t}^{l} - NK}{t - nk} + {t}^{l} = ( \frac{{q}_{u}}{t - nm} + \frac{{q}_{V}}{t - mk} + \frac{{q}_{w}}{t - nk} + 1 ) \cdot {t}^{l} - \frac{{q}_{u}}{t - nm} \cdot NM - \frac{{q}_{V}}{t - mk} \cdot MK - \frac{{q}_{w}}{t - nk} \cdot NK$$

Denote q=qᵤ+qᵥ+q_{w}. The arithmetic complexity of an [symbol] n,n,n; t [symbol] -algorithm is:

$$( \frac{q}{t - {n}^{2}} + 1 ) {N}^{{log}_{n} ( t )} - \frac{q}{t - {n}^{2}} \cdot {N}^{2}$$

Proof: Observe that l=logₙ(N), thus t^{l}=N^{log}^{ₙ}^{(t)}. Substituting this equality as detail above, and letting N=M=K, yields the expression above.

Let R be a ring and let φ₁: R^{S}^{₁}→R^{s}^{₂} be a linear transformation, where s₁≠s₂. Denote by q_{φ} the additive complexity (as detail herein) of φ₁. Let l∈ [symbol] and denote S₁=(s₁)^{l}, S₂=(s₂)^{l}. Let v∈R^{s}^{₁} be a vector. The arithmetic complexity of computing φₗ(v) is:

$${F}_{φ} ( {S}_{1} ) = \frac{{q}_{φ}}{{s}_{1} - {s}_{2}} \cdot ( {S}_{1} - {S}_{2} )$$

Proof: φₗ(v) is computed recursively. In each recursive call, φ₁ is invoked on each of the s₁ blocks of v, whose sizes are

$$\frac{{S}_{1}}{{s}_{1}} .$$

In each call, φ₁ performed q_{φ} aritnmetic operations on the resulting blocks, whose sizes are

$$\frac{{S}_{2}}{{s}_{2}} .$$

### Therefore:

$${F}_{φ} ( {S}_{1} ) = {s}_{1} \cdot {F}_{φ} ( \frac{{S}_{1}}{{s}_{1}} ) + {q}_{φ} \cdot \frac{{S}_{2}}{{s}_{2}}$$

Moreover, F_{φ}(1)=0 since handling a single scalar value requires no operations. Thus:

$$\begin{matrix}{F}_{φ} ( {S}_{1} ) = {\sum }_{r = 0}^{l - 1} {( {s}_{1} )}^{r} \cdot {q}_{φ} \frac{{s}_{2}}{{( {s}_{2} )}^{r + 1}} \\ = {q}_{φ} \cdot \frac{{S}_{2}}{{s}_{2}} \cdot {\sum }_{r = 0}^{l - 1} {( \frac{{s}_{1}}{{s}_{2}} )}^{r} \\ = \frac{{q}_{φ} \cdot {S}_{2}}{{s}_{2}} \cdot ( \frac{{S}_{1}}{{S}_{2}} - 1 ) \cdot \frac{{s}_{2}}{{s}_{1} - {s}_{2}} = \frac{{q}_{φ}}{{s}_{1} - {s}_{2}} \cdot ( {S}_{1} - {S}_{2} )\end{matrix}$$

The expression above holds for s₁≠s₂. If s₁=s₂ the complexity is:

$${F}_{φ} ( {S}_{1} ) = {\sum }_{r = 0}^{l - 1} {( {s}_{1} )}^{r} \cdot {q}_{φ} \frac{{S}_{1}}{{( {s}_{1} )}^{r + 1}} = \frac{{q}_{φ}}{{s}_{1}} \cdot {S}_{1} \cdot {log}_{{s}_{1}} {S}_{1}$$

The arithmetic complexity incurred by the “core” of the algorithm; the recursive-bilinear [symbol] was computed:

Let R be a ring and let U,V and W be the matrices of an [symbol] n, m, k; t [symbol] -algorithm, where U∈R^{t×nm},v∈R^{t×mk}, W∈R^{t×nk}, and let U_{φ}, V_{ψ}, W_{τ}, φ, ψ, τ be a decomposition of U, V, W with levels rᵤ,rᵥ,r_{w}, as above. Let qᵤ_{_{φ}}, qᵥ_{_{ψ}}, q_{w}_{ᵣ} be the additive complexities of U_{φ}, V_{ψ}, W_{τ}, correspondingly. Let l∈ [symbol] and denote (mᵤ, mᵥ, m_{w})=(t−rᵤ, t−rᵥ, t−r_{w}) and (Mᵤ, Mᵥ, M_{w})=(mᵤ^{l}, mᵥ^{l}, m_{w}^{l}). Similarly, denote (N, M, K)=(n^{l}, m^{l}, k^{l}). Let A∈R^{N×M}, B∈R^{M×K} and denote Ã=φₗ(A)∈R^{M}^{ᵤ}, \tilde{B}=ψₗ(B)∈R^{M}^{ᵥ}. Let [symbol] be a recursive-bilinear algorithm defined by the matrices U , V_{ψ}, and W_{τ}.

The arithmetic complexity of [symbol] (Ã, \tilde{B}) is:

$${F}_{A L G} ( {M}_{u} , {M}_{v} ) = ( \frac{{q}_{{u}_{φ}}}{{r}_{u}} + \frac{{q}_{{v}_{ψ}}}{{r}_{v}} + \frac{{q}_{{w}_{τ}}}{{r}_{w}} + 1 ) \cdot {t}^{l} - \frac{{q}_{{u}_{φ}}}{{r}_{u}} \cdot {M}_{u} - \frac{{q}_{{v}_{ψ}}}{{r}_{v}} \cdot {M}_{v} - \frac{{q}_{{w}_{τ}}}{{r}_{w}} \cdot {M}_{w}$$

Proof: [symbol] is a recursive algorithm. In each step, [symbol] performs t recursive calls (multiplications) of blocks of size

$$\frac{{M}_{u}}{{m}_{u}} , \frac{{M}_{v}}{{m}_{v}} ,$$

producing mocks of size

$$\frac{{M}_{w}}{{m}_{w}} .$$

Encoding U requires qᵤ_{_{φ}} aritnmetic operations on blocks of size

$$\frac{{M}_{u}}{{m}_{u}} .$$

Similarly, encoding V requires qᵥ_{_{ψ}} arithmetic operations on blocks of size

$$\frac{{M}_{v}}{{m}_{v}} .$$

Decoding the multiplicands requires q_{w}_{_{τ}} arithmetic operations on blocks of size

$$\frac{{M}_{w}}{{m}_{w}} .$$

### Therefore:

$$\begin{matrix}{F}_{A L G} ( {M}_{u} , {M}_{v} ) = t \cdot {F}_{A L G} ( \frac{{M}_{u}}{{m}_{u}} , \frac{{M}_{v}}{{m}_{v}} ) \\ + {q}_{{v}_{ψ}} \cdot \frac{{M}_{v}}{{m}_{v}} + {q}_{{w}_{τ}} \cdot \frac{{M}_{w}}{{m}_{w}}\end{matrix}$$

Furthermore, observe that F_{ALG}(1,1)=1 since multiplying scalar values requires a single arithmetic operation. Therefore:

$$\begin{matrix}{F}_{A L G} ( {M}_{u} , {M}_{v} ) = [ {Σ}_{r = 0}^{l - 1} ( {q}_{{u}_{φ}} \frac{{M}_{u}}{{m}_{u}^{r + 1}} + {q}_{{v}_{ψ}} \frac{{M}_{v}}{{m}_{v}^{r + 1}} + {q}_{{w}_{τ}} \frac{{M}_{w}}{{m}_{w}^{r + 1}} ) \cdot {t}^{r} ] \\ + \frac{{q}_{{u}_{φ}} {M}_{u}}{{r}_{u}} ( \frac{{t}^{l}}{{M}_{u}} - 1 ) + \frac{{q}_{{v}_{ψ}} {M}_{v}}{{r}_{v}} ( \frac{{t}^{l}}{{M}_{v}} - 1 ) \\ + \frac{{q}_{{w}_{τ}} {M}_{w}}{{r}_{w}} ( \frac{{t}^{l}}{{M}_{w}} - 1 ) + {t}^{l} \\ = ( \frac{{q}_{{u}_{φ}}}{{r}_{u}} + \frac{{q}_{{v}_{ψ}}}{{r}_{v}} + \frac{{q}_{{w}_{τ}}}{{r}_{w}} + 1 ) \cdot {t}^{l} - \frac{{q}_{{u}_{φ}}}{{r}_{u}} \cdot {M}_{u} \\ - \frac{{q}_{{v}_{ψ}}}{{r}_{v}} \cdot {M}_{v} - \frac{{q}_{{w}_{τ}}}{{r}_{w}} \cdot {M}_{w}\end{matrix}$$

Let R be a ring. Let l∈ [symbol] and denote N=n^{l}, M=m^{l}, K=k^{l}. Let A∈R^{N×M}, B∈R^{M,K} be two matrices. Let DRB be as defined above, and let U₁₀₀ , V_{ψ}, W_{τ}, φ, ψ, τ be a decomposition of U, V, W with levels rᵤ, rᵥ, r_{w}, as above. Let [symbol] be a recursive-bilinear algorithm defined by the matrices U_{φ}, V_{ψ}, W_{τ}. The arithmetic complexity of DRB(A, B) is:

$$\begin{matrix}{F}_{D R B} ( N , M , K ) = {F}_{φ} ( N M ) + {F}_{ψ} ( M K ) + {F}_{A L G} ( {M}_{u} , {M}_{v} ) + {F}_{τ} ( {M}_{w} ) \\ = ( \frac{{q}_{{u}_{φ}}}{{r}_{u}} + \frac{{q}_{{v}_{ψ}}}{{r}_{v}} + \frac{{q}_{{w}_{τ}}}{{r}_{w}} + 1 ) \cdot {t}^{l} \\ + ( \frac{{q}_{φ}}{t - {r}_{u} - n m} - \frac{{q}_{{u}_{φ}}}{{r}_{u}} ) \cdot {( t - {r}_{u} )}^{l} \\ + ( \frac{{q}_{ψ}}{r - {r}_{v} - m k} - \frac{{q}_{{v}_{ψ}}}{{r}_{v}} ) \cdot {( t - {r}_{v} )}^{l} \\ + ( \frac{{q}_{τ}}{t - {r}_{w} - n k} - \frac{{q}_{{w}_{τ}}}{{r}_{w}} ) \cdot {( t - {r}_{w} )}^{l} \\ - \frac{{q}_{φ} \cdot NM}{t - {r}_{u} - n m} - \frac{{q}_{ψ} \cdot MK}{t - {r}_{v} - m k} - \frac{{q}_{τ} \cdot NK}{t - {r}_{w} - n k}\end{matrix}$$

Proof: The arithmetic complexity was computed by adding up the complexities of each stage. Adding up all terms yields the expression above. The complexities of the two initial transformations φₗ(\vec{A}) and ψₗ(\vec{B}), and of the final transformation τₗ(\tilde{C}) are computed. Then the arithmetic complexity of [symbol] (Ã,\tilde{B}) is computed. Adding up all terms yields the expression above. The leading coefficient of DRB is:

$$\frac{{q}_{{u}_{φ}}}{{r}_{u}} + \frac{{q}_{{v}_{ψ}}}{{r}_{v}} + \frac{{q}_{{w}_{τ}}}{{r}_{w}} + 1$$

### IO-Complexity

The IO-Complexity of the fast recursive transformations was analyzed. The analysis corresponded to the sequential model with two memory levels, where the fast memory is of size M. In this model the IO complexity captured the number of transfers between the memory hierarchy, namely to and from the fast memory. Results of computations can be written out directly to the main memory without necessitating transfers from fast memory.

Let R be a ring, and let φ₁:R^{s}^{₁}→R^{s}^{₂} be a linear transformation. Denote by q_{φ}, the additive complexity of φ₁. Let l∈ [symbol] and denote S₁=(s₁)^{l}, S₂=(s₂)^{l}. Let v∈R^{S}^{₁} be a vector. Let

$$f = {log}_{{s}_{1}} \frac{{S}_{1}}{\sqrt{\frac{M}{2}}} .$$

The IO-Complexity of computing φₗ(v) is:

$${IO}_{φ} ( {S}_{1} , M ) = ( \frac{3 {q}_{φ}}{{s}_{1} - {s}_{2}} \cdot ( {( \frac{{s}_{1}}{{s}_{2}} )}^{f} - 1 ) ) \cdot {S}_{2} + ( 2 \cdot \frac{M + {( {s}_{2} )}^{f}}{M} ) \cdot {S}_{1}$$

Proof: The proof is similar to that of the arithmetic complexity, the main difference being the halting criteria and the complexity at the base-case. φₗ is computed recursively. At each step, φₗ₋₁ is applied s₁ times to vectors or size

$$\frac{{S}_{1}}{{s}_{1}} ,$$

proaucing vectors of size

$$\frac{{S}_{2}}{{s}_{2}} .$$

When 2S₁≤M, two input blocks fit inside the fast memory, requiring only M read operations, and the output is written out requiring S₂ writes. When the problem does not fit inside fast memory, each addition requires at most 3 data transfers: 2 reads for the inputs, and one write for the output. Therefore:

$$I {O}_{φ} ( {S}_{1} , M ) \leq ( \begin{matrix}{s}_{1} \cdot I {O}_{φ} ( \frac{{s}_{1}}{{s}_{1}} , M ) + 3 {q}_{φ} \cdot \frac{{s}_{2}}{{s}_{2}} & 2 {S}_{1} > M \\ M + {S}_{2} & 2 {S}_{1} \leq M\end{matrix}$$

Solving the recurrence the following was obtained:

$$\begin{matrix}I {O}_{φ} ( {S}_{1} , M ) \leq {\sum }_{r = 0}^{f - 1} ( 3 {q}_{φ} \cdot \frac{{( {s}_{1} )}^{r}}{{( {s}_{2} )}^{l - r - 1}} ) + ( M + {( {s}_{2} )}^{f} ) \cdot \frac{2 {S}_{1}}{M} \\ = 3 {q}_{φ} \cdot {( {s}_{2} )}^{l - 1} {\sum }_{r = 0}^{f - 1} {( \frac{{s}_{1}}{{s}_{2}} )}^{r} + ( M + {( {s}_{2} )}^{f} ) \cdot \frac{2 {S}_{1}}{M} \\ = ( \frac{3 {q}_{φ}}{{s}_{1} - {s}_{2}} \cdot ( {( \frac{{s}_{1}}{{s}_{2}} )}^{f} - 1 ) ) \cdot {S}_{2} + ( 2 \cdot \frac{M + {( {s}_{2} )}^{f}}{M} ) \cdot {S}_{1}\end{matrix}$$

### Full Decomposition

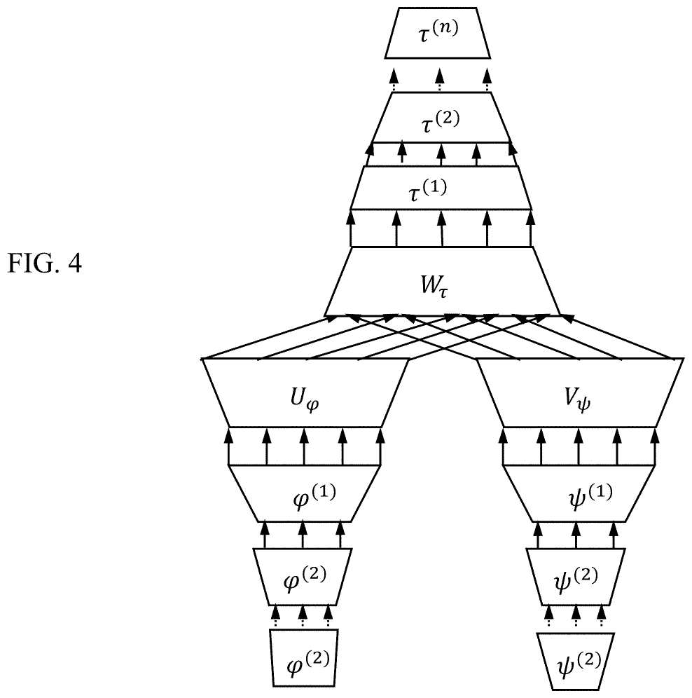

Above, a decomposition in which each of the encoding/decoding matrices of an [symbol] n, m, k; t [symbol] -algorithm is split into a pair of matrices was demonstrated. Such a decomposition is referred to as a first-order decomposition. First-order decompositions allowed a reduction of the leading coefficient, at the cost of introducing new low-order monomials. The same approach can then be repeatedly applied to the output of the decomposition, thus also reducing the coefficients of low-order monomials (see FIG. 4).

Let Q∈R^{t×s} be an encoding or decoding matrix of an [symbol] n, m, k; t [symbol] -algorithm. The c-order decomposition of Q is defined as:

Q=Q_{φ}·φ⁽¹⁾·φ⁽²⁾· . . . ·φ^{(c)=}Q₁₀₀·%529 ᵢ₌₁^{c}φ⁽ⁱ⁾

where φ⁽ⁱ⁾∈R^{h}^{ᵢ}^{×h}^{ᵢ₊₁}, and ∀i∈[c]:hᵢ>hᵢ₊₁. Furthermore, h_{c}=s. Interestingly, full decompositions may result in zero coefficients for some of the lower-order monomials. In the first-order decomposition, the decomposition level determines the degree of the lower-order monomial; higher decomposition levels yield lower-degree monomial incurred by the transformation cost. In a full decomposition, some lower-order monomials might cancel out altogether, as their transformation costs may cancel out some terms telescopically. See Table 2 below for an example of the full decomposition of the (3,3,3; 23)-algorithm.

TABLE 2
Example of Arithmetic Complexity: [symbol] 3, 3, 3 [symbol] -Algorithms

| ALGORITHM | ARITHMETIC COMPLEXITY |
|---|---|
| [symbol] 3,3,3; 27 [symbol] Classical | 2n³ − n² |
| [symbol] 3,3,3; 23 [symbol] Original Algorithm | 7.93n^{log}^{₃}²³ − 6.93n² |
| [symbol] 3,3,3; 23 [symbol] Alternative Basis | 5.36n^{log}^{₃}²³ + 3.22n²log₃n − 4.36n² |
| [symbol] 3,3,3; 23 [symbol] Decomposed | 2n^{log}^{₃}²³ + 6.75n^{log}^{₃}²¹ − 7.75n² |
| [symbol] 3,3,3; 23 [symbol] Fully Decomposed | 2n^{log}^{₃}²³ + 3n^{log}^{₃}²⁰ + 2n^{log}^{₃}¹⁴ + |
| | 2n^{log}^{₃}¹² + 2n^{log}^{₃}¹¹ + 33n^{log}^{₃}¹⁰ − 43n² |

### Lower Bounds

### Optimal Decomposition

The matrices corresponding to several matrix multiplication algorithms were decomposed. Some algorithms exhibited an optimal decomposition, namely the leading coefficient of their arithmetic complexity is 2. This is optimal, as shown in the following claim:

Let U,V,W be the encoding/decoding matrices of an [symbol] n, m, k; t [symbol] -algorithm. W.l.o.g, none of U,V,W contain an all-zero row. The leading coefficient of the arithmetic complexity of DRB is at least 2.
Proof: Let U_{φ}, V_{ψ}, W_{τ}, φ, ψ, τ be a decomposition of U, V, W with levels rᵤ,rᵥ,r_{w}. The additive complexities satisfy:
   qᵤ_{_{φ}}=nnz(U_{φ})+nns(U_{φ})−rows(U_{φ)}
   qᵥ_{_{ψ}}=nnz(V_{ψ})+nns(V_{ψ})−rows(V_{ψ})
   q_{w}_{_{τ}}=nnz(W_{τ})+nns(W_{τ})−cols(W_{τ})
   As U,V,W do not have all-zero rows, neither can U_{φ}, V_{ψ}, W_{τ}. Consequently, U_{φ}, V_{ψ}, W_{τ} all have at least one non-zero element in every row:
   nnz(U_{φ})≥rows(U_{φ})
   nnz(V_{ψ})≥rows(V_{ψ})
   nnz(W_{τ})≥rows(W_{τ})
Therefore:
   qᵤ_{_{φ}}≥0,
   qᵥ_{_{ψ}}≥0,
   q_{w}_{_{τ}}=rows(W_{τ})−cols(W_{τ})=r_{w}

The proof now follows from above.

All classical multiplication algorithms optimally decompose. However, the leading coefficient of classical algorithms is already 2 without decompositions, the minimal leading coefficient. Therefore, their decomposition does not allow for any further acceleration.

### A Lower-Bound on the Leading Coefficient of (2,2,2; 7)-Algorithms

It has been shown previously that 15 additions are necessary for any [symbol] 2,2,2; 7 [symbol] -algorithm, assuming the input and output are given in the standard basis. Karstadt and Schwartz (2017) proved a lower-bound of 12 arithmetic operations for any [symbol] 2,2,2; 7 [symbol] -algorithm, regardless of the input and output bases, thus showing their algorithm obtains the optimum.

In the decomposed matrix multiplication regime, the input and output are given in bases of a different dimension. This could have allowed for sidestepping the aforementioned lower bound, by requiring a smaller number of linear operations and thus, perhaps, a smaller leading coefficient. It is proven herein that this is not the case. It is proven that while 12 arithmetic operations are not required in this model (indeed 4 suffice), the leading coefficient of any [symbol] 2,2,2; 7 [symbol] -algorithm remains at least 5, regardless of the decomposition level used.

Let Q be an encoding/decoding matrix of a [symbol] 2,2,2; 7 [symbol] -algorithm. Q has no all-zero rows.
Proof: The minimal number of multiplications for any [symbol] 2,2,2 [symbol] -algorithm was shown to be 7. Assume towards a contradiction that Q is an encoding matrix with an all-zeros row. Thus, the corresponding multiplicand is zero, allowing the output to be computed using only 6 multiplications, in contradiction to the previous lower bound. Similarly, if Q is a decoding matrix with an all zeros row, the corresponding multiplicand would always be discarded, once again allowing 6 multiplications, in contradiction to the previous lower bound.

For example, Q_{φ} has no all-zero rows, since a zero row in Q_{φ} implies such a row in Q. Let Q be an encoding/decoding matrix of a [symbol] 2,2,2; 7 [symbol] -algorithm. Q has no duplicate rows. Q_{φ} has no duplicate rows, since duplicate rows in Q_{φ} imply duplicates in Q. Let ALG be a [symbol] 2,2,2; 7 [symbol] -algorithm. The leading coefficient of ALG is 5.
Proof: Let U, V, W∈R^{7×4} be the encoding/decoding matrices of ALG. Denote their decomposition as follows:
U_{φ}∈R^{7×(t-r}^{ᵤ}⁾φ∈R^{(7-r}^{ᵤ}^{)×4}rᵤ∈[3]
V_{ψ}∈R^{7×(t-r}^{ᵥ}⁾ψ∈R^{(7-r}^{^{v}}^{)×4}rᵥ∈[3]
W_{τ}∈^{7×(t-r}^{_{w}}⁾τ∈R^{(7-r}^{_{w}}^{)×r}τ_{w}∈[3]

For r=3, the matrices φ, ψ, τ are square, therefore this case is identical to the Alternative Basis model, in which each encoding/decoding matrix must have at-least 10 non-zero elements, therefore:
qᵤ_{_{φ}}=nnz(U_{φ})−rows(U_{φ})≥10−7=3
qᵥ_{_{ψ}}=nnz(V_{ψ})−rows(V_{ψ})≥10−7=3
q_{w}_{_{τ}}=nnz(W_{τ})−cols(W_{τ})≥10−4=6

Next, the decomposition level r=2 is handled. Let Q be an encoding/decoding matrix of a [symbol] 2,2,2; 7 [symbol] -algorithm, and let Q=Q_{φ}·φ, where Q_{φ}∈R^{7×5}, φ∈R^{5×4}. Each of Q_{φ}'s rows contain at least a single non-zero element. However, there are at most 5 such rows, therefore the remaining two rows must contain at-least two non-zero elements. Consequently:

nnz(Q_{φ})≥5+2+2=9

Thus, the corresponding additive complexities satisfy:
qᵤ_{_{φ}}=nnz(U_{φ})−rows(U_{φ})≥9−7=2
qᵥ_{_{ψ}}=nnz(V_{ψ})−rows(V_{ψ})≥9−7=2
q_{w}_{_{τ}}=nnz(W_{τ})−cols(W_{τ})≥9−5=4

Lastly, the decomposition level r=1 is handled. Let Q be an encoding/decoding matrix of a [symbol] 2,2,2; 7 [symbol] -algorithm. Q=Q_{φ}·φ, where Q_{φ}∈R^{7×6}, φ∈R^{6×4}. Once again,Q_{φ} has no duplicate rows, and at least one non-zero element in each row. Therefore, 6 of Q_{φ}'s rows have at least one non-zero element, and the remaining row must contain at least 2 non-zeros. Therefore (Q(_{φ})≥8, and:
Qᵤ_{^{φ}}=nnz(U_{φ})−rows(U_{φ})≥8−7=1
qᵥ_{^{ψ}}=nnz(V_{ψ})−rows(V_{ψ})≥8−7=1
q_{w}_{^{τ}}=nnz(W_{τ})−cols(W_{τ})≥8−6=2

Putting the above terms together, we observe that irrespective of the decomposition dimension, the arithmetic costs satisfy:

$$cos t ( {U}_{φ} ) = \frac{{q}_{{u}_{φ}}}{{r}_{u}} {=}_{{r}_{u} = 3} \frac{3}{3} {=}_{{r}_{u} = 2} \frac{2}{2} {=}_{{r}_{u} = 1} \frac{1}{1} = 1$$

$$cos t ( {V}_{ψ} ) = \frac{{q}_{{v}_{ψ}}}{{r}_{v}} {=}_{{r}_{v} = 3} \frac{3}{3} {=}_{{r}_{v} = 2} \frac{2}{2} {=}_{{r}_{v} = 1} \frac{1}{1} = 1$$

$$co st ( {W}_{τ} ) = \frac{{q}_{{w}_{τ}}}{{r}_{w}} {=}_{{r}_{w} = 3} \frac{6}{3} {=}_{{r}_{w} = 2} \frac{4}{2} {=}_{{r}_{w} = 1} \frac{2}{1} = 2$$

Thus, in all cases the leading coefficient is:

cost(U_{φ})+cost(V_{ψ})+cost(W_{τ})+1=5

### Finding Sparse Decompositions

As the additive complexity of an [symbol] n, m, k; t [symbol] -algorithm is determined by the number of non-zero and non-singleton elements in its encoding/decoding matrices, sparse decompositions of the aforementioned matrices were wanted, preferably containing only singletons.

Formally, let Q∈R^{t×n} be an encoding or decoding matrix, and let r∈[t−n]. A decomposition of Q into Q_{φ}∈R^{t×(t-r)}, φ∈R^{(t-r)×n} was wanted, satisfying:
minimize: nnz(Q_{φ})+nns(Q_{φ})
subject to: Q=Q_{φ}·φ

This work focused on minimizing non-zeros, for two main reasons. First, many encoding/decoding matrices contain only singleton values, and moreover the resulting decompositions had only singletons. Furthermore, minimizing the number of non-zeros also bounds the number of non-singletons, as (A)≤(A).

The optimization problem above whose objective is minimizing only the number of non-zeros is known as the Dictionary Learning problem, which is NP-Hard and hard to approximate within a factor of 2^{log}^{^{1−ε}}^{m}, ∀ε>0 (unless NP⊆DTIME(m^{poly(logm)})). Nevertheless, due to the relatively small dimensions of many practical (n, m, k; t)-algorithm base cases, the aforementioned problem can feasibly be tackled with currently available computational power.

Let Q be an encoding or decoding matrix of an [symbol] n, m, k; t [symbol] -algorithm, and let r∈ [symbol] be the level decomposition wanted for Q. If Q has no all-zero rows, then Q_{φ}) has non-zeros in every row and every column.
Proof: If Q does not contain zero rows, neither does Q_{φ}. Assume towards a contradiction there exists an all-zero column in Q_{φ}. Then an r−1 decomposition is implied, since:

$${iU}_{φ}^{′} 0 {U}_{φ}^{″} ccc ( c c c ) {φ}^{′} {v}_{i} {φ}^{″} = ( {U}_{φ}^{′} {U}_{φ}^{″} ) ( \begin{matrix}{φ}^{′} \\ {φ}^{″}\end{matrix} ) \qquad$$

Thus Q_{φ} has non-zeros in every row and every column.

The sparsest structure with non-zeros in every row and every column is a (possibly permuted) diagonal matrix D₍ₜ₋ᵣ₎. Since the goal is to minimize both the number of non-zeros and the number of non-singletons, it is assumed Q_{φ} contains a (possibly permuted) identity matrix. Let P_{π} be the permutation matrix which permutes Q_{φ}'s rows such that the first t−r rows contain the identity matrix. Then multiplying by P_{π}:

$${P}_{π} \cdot Q = {P}_{π} \cdot {Q}_{φ} \cdot φ = ( \begin{matrix}1 & & \\ & ⋱ & \\ & & 1 \\ & . . . & \end{matrix} ) \cdot φ$$

Thus ∀i∈[t−r]: φᵢ=(P_{π}·Q)ᵢ, and therefore φ is uniquely determined by the location of the identity matrix's rows. Put together, the sparsification process works as follows:
(i) Choose the location of the identity matrix rows in Q₁₀₀
(ii) Compute φ based on the above selection
(iii) For every remaining row of vᵢ of Q_{φ}, solve:

$${v}_{i} = {argmin}_{\vec{x} ∈ {R}^{t - r}} ( \{ nnz ( \vec{x} ) : {φ}^{T} \cdot {x}^{T} = ( {Q}_{i} ) {}^{T} \} )$$

The latter optimization problem is known as the Compressed Sensing problem. Nevertheless, many algorithms attempt to solve relaxations of the above problem. While these algorithms' optimization goals are different to that of Compressed Sensing, their outputs may converge under some conditions (i.e., the null-space property).

Due to the relatively small dimensions of the encoding/decoding matrices, all possible placements of non-zero elements in z were iterated through, solving the corresponding least-squares instance for each such choice. This approach, while far slower than the aforementioned algorithms, resulted in far sparser solutions, as quite large portions of the solution-space were enumerated.

The present invention for reducing the hidden constant of the arithmetic complexity of fast matrix multiplication utilizes a richer set of decompositions, allowing for even faster practical algorithms. The present invention has the same asymptotic complexity of the original fast matrix multiplication algorithms, while significantly improving their leading coefficients.

Highly optimized implementations of the “classical” algorithm often outperform fast matrix multiplication algorithms for sufficiently small matrices. The present invention obtains fast matrix multiplication algorithms whose leading coefficients match that of the classical algorithm and may therefore outperform the classical algorithm even for relatively small matrices.

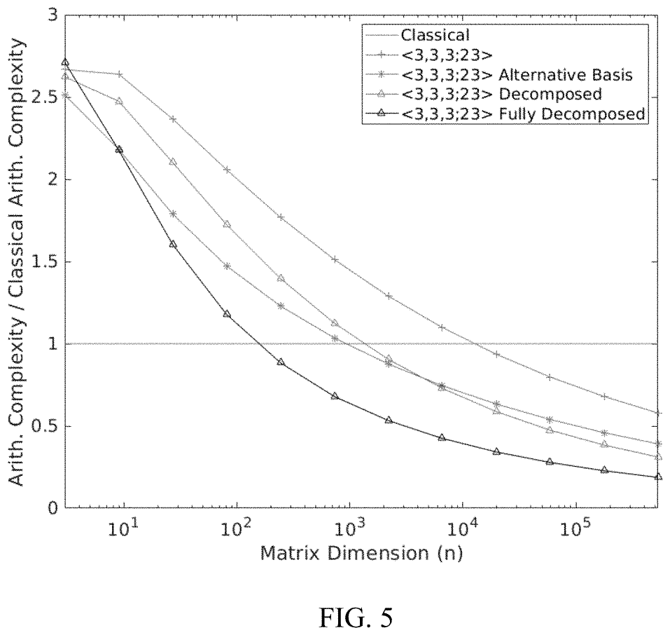

Iteratively applying the decomposition scheme allows for the reduction of the coefficients of lower-order monomials. For algorithms in which the degrees of lower-order monomials are quite close to that of the leading monomial, this further optimization can significantly improve the arithmetic complexity (see FIG. 5).

The algorithm of the present invention relies on a recursive divide-and-conquer strategy. Thus, the straight-forward serial recursive implementation matches the communication cost lower-bounds. For parallel implementations, the BFS-DFS method can be used to attain these lower bounds.

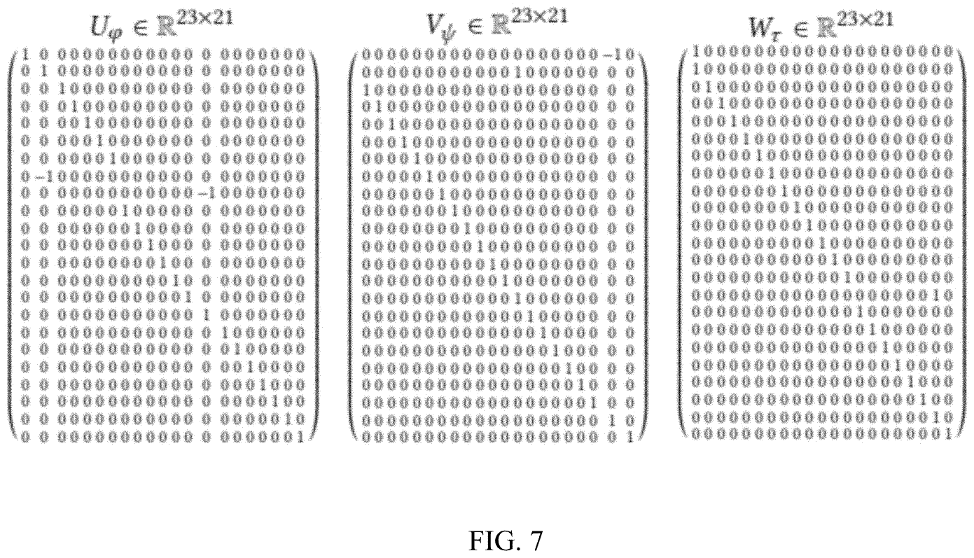

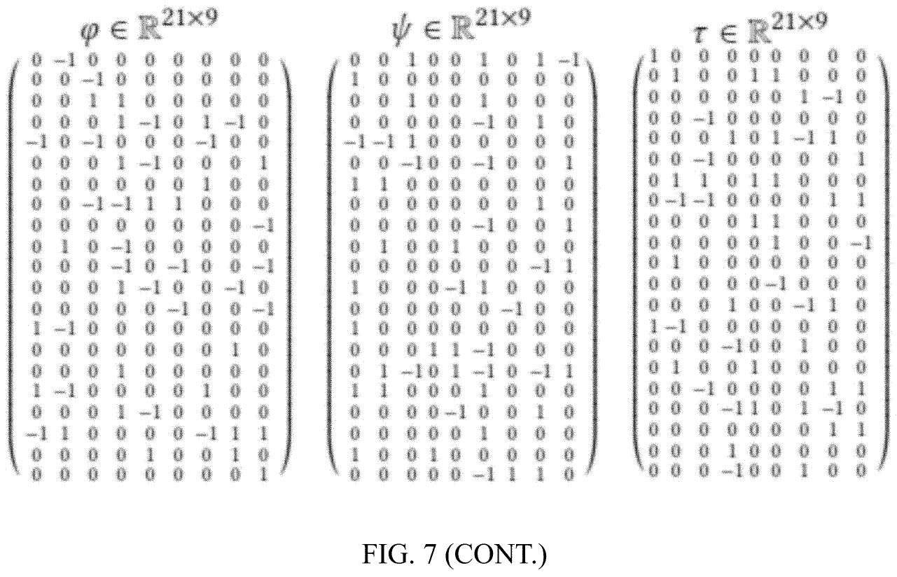

An optimal decomposition of the [symbol] 3,3,3; 23 [symbol] -algorithm can be seen in FIG. 7. Thanks to its leading coefficient of 2, the decomposed [symbol] 3,3,3; 23 [symbol] -algorithm can outperform the [symbol] 2,2,2; 7 [symbol] -algorithm on small matrices, despite its larger exponent. The optimal decomposition of the [symbol] 3,3,3; 23 [symbol] -algorithm is due to Ballard and Benson. All three encoding/decoding matrices contain duplicate rows, and thus optimally decompose. In contrast, the [symbol] 3,3,3; 23 [symbol] -algorithm due to Laderman contains no duplicate rows in any of the matrices, and therefore exhibits a leading coefficient of at-least 5 for any level of decomposition. Johnson and McLoughlin described a parametric family of (3,3,3; 23)-algorithms. Any choice of parameters results in duplicate rows in the encoding matrices, and moreover choosing x=y=z=1 yields duplicate rows in all three matrices, thus resulting in an optimally decomposing algorithm, similar to that of Ballard and Benson.

In addition to Smirnov's [symbol] 6,3,3; 40 [symbol] -algorithm, the present invention decomposed a [symbol] 6,3,3; 40 [symbol] -algorithm, of Tichaysks'y and Kovác̆. The original algorithm has a leading coefficient of 79.28 which was improved to 7 (a reduction by 91.1%), the same leading coefficient that was obtained for Smirnov's algorithm.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions and/or hardware.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system comprising:
at least one hardware processor; and
a non-transitory computer-readable storage medium having program instructions embodied therewith, the program instructions executable by said at least one hardware processor to:
receive a first matrix and a second matrix,
compute a first transformation of said first matrix, to obtain a transformed said first matrix,
compute a second transformation of said second matrix, to obtain a transformed said second matrix,
apply a bilinear computation to said transformed first matrix and said transformed second matrix, thereby producing a transformed multiplied matrix; and
apply a third transformation to said transformed multiplied matrix, to obtain a product of said first and second matrices,
wherein at least one of said first, second, and third transformations is a non-homomorphic transformation into a linear space of any intermediate dimension.

2. The system of claim 1, wherein said non-homomorphic transformation is a decomposition.

3. The system of claim 2, wherein said decomposition is a full decomposition.

4. The system of claim 1, wherein said program instructions are further executable to select which at least one of said first, second, and third transformations is a non-homomorphic transformation into a linear space of any intermediate dimension.

5. The system of claim 4, wherein said selecting is based, at least in part, on a dimension of each of said first and second matrices.

6. The system of claim 2, wherein said decomposition comprises a set of fast recursive transformations.

7. The system of claim 2, wherein said decomposition is determined by solving at least one sparsification problem.

8. The system of claim 7, wherein said program instructions are further executable to use (i) a first encoding matrix for said first transformation, (ii) a second encoding matrix for said second transformation, and (iii) a decoding matrix for said third transformation, wherein said at least one sparsification problem is at least one from the group consisting of: sparsification of said first encoding matrix, sparsification of said second encoding matrix, and sparsification of said decoding matrix.

9. The system of claim 8, wherein solving said at least one sparsification problem comprises simultaneously solving three sparsification problems, one for each of:
said first encoding matrix, said second encoding matrix, and said decoding matrix.

10. A method comprising:
receiving a first matrix and a second matrix;
computing a first transformation of said first matrix, to obtain a transformed said first matrix;
computing a second transformation of said second matrix, to obtain a transformed said second matrix;
applying a bilinear computation to said transformed first matrix and said transformed second matrix, thereby producing a transformed multiplied matrix; and
applying a third transformation to said transformed multiplied matrix, to obtain a product of said first and second matrices,
wherein at least one of said first, second, and third transformations is a non-homomorphic transformation into a linear space of any intermediate dimension.

11. The method of claim 10, wherein said non-homomorphic transformation is a decomposition.

12. The method of claim 11, wherein said decomposition is a full decomposition.

13. The method of claim 10, further comprising selecting which at least one of said first, second, and third transformations is a non-homomorphic transformation into a linear space of any intermediate dimension.

14. The method of claim 13, wherein said selecting is based, at least in part, on a dimension of each of said first and second matrices.

15. The method of claim 11, wherein said decomposition comprises a set of fast recursive transformations.

16. The method of claim 11, wherein said decomposition is determined by solving at least one sparsification problem.

17. The method of claim 16, further comprising using (i) a first encoding matrix for said first transformation, (ii) a second encoding matrix for said second transformation, and (iii) a decoding matrix for said third transformation, wherein said at least one sparsification problem is at least one from the group consisting of: sparsification of said first encoding matrix, sparsification of said second encoding matrix, and sparsification of said decoding matrix.

18. The method of claim 17, wherein solving said at least one sparsification problem comprises simultaneously solving three sparsification problems, one for each of: said first encoding matrix, said second encoding matrix, and said decoding matrix.

19. The method of claim 10, wherein a leading coefficient of an arithmetic complexity of said bilinear computation is 2.

20. A computer program product comprising a non-transitory computer-readable storage medium having program instructions embodied therewith, the program instructions executable by at least one hardware processor to:
receive a first matrix and a second matrix;
compute a first transformation of said first matrix, to obtain a transformed said first matrix;
compute a second transformation of said second matrix, to obtain a transformed said second matrix;
apply a bilinear computation to said transformed first matrix and said transformed second matrix, thereby producing a transformed multiplied matrix; and
apply a third transformation to said transformed multiplied matrix, to obtain a product of said first and second matrices,
wherein at least one of said first, second, and third transformations is a non-homomorphic transformation into a linear space of any intermediate dimension.

21.-41. (canceled)
